(19) United States
(12) Patent Application Publication
(10) Pub. No.: US 2004/0055479 A1
(43) Pub. Date: Mar. 25, 2004

(54) Juice extractor having soft start motor control

(75) Inventors: Keith R. Bunce, Lakeland, FL (US); Michael B. Mas, Lakeland, FL (US); James Brian Greer, Lakeland, FL (US); Gregory W. Schrader, Lakeland, FL (US)

Correspondence Address: WOOD, HERRON & EVANS, LLP, 2700 CAREW TOWER, 441 VINE STREET, CINCINNATI, OH, 45202, US

(73) Assignee: FMC Technologies, Inc, Chicago, IL

(21) Appl. No.: 10/228,608

(22) Filed: Aug. 27, 2002

(51) Int. Cl. B30B 9/02

(52) U.S. Cl. 100/37

(57) ABSTRACT

A cam-driven juice extractor that achieves steady state operation without the start up problems associated with traditional juice extractors. A soft start controller is coupled to the juice extractor motor to gradually increase motor voltage during a preset and controllable acceleration and voltage ramp time.

### FIELD OF THE INVENTION

This invention relates generally to the field of juice extractors and, more specifically, to juice extractors designed to remove the juice from fruits having peels.

### BACKGROUND OF THE INVENTION

One type of mass production juice extractor includes a series of juice extractor units that are ganged together. Each juice extractor unit includes upper and lower cups for supporting the fruit and squeezing the fruit therebetween. The sides of both upper and lower cups have fingers that intermesh or interdigitate together. The upper cups are mounted to a cup drive beam, which moves in a fixed up and down path by means of a cam-drive positioned at the top of the juice extractor machine. The upper cups move into the bottom cups, which remain rigidly positioned.

A fruit, such as an orange, is initially fed into the bottom cup by a cam-operated feeding device, which essentially tosses the fruit in the bottom cup. The upper cup then descends into the lower cup. The fruit is pressed against a sharp circular cutter positioned at the top of a strainer tube adjacent the lower cup, and against a similar cutter positioned in the upper cup. The two circular cutters cut plugs into both the top and bottom portions of the fruit as the interdigitating fingers of the two cups mesh together. At the same time, the inner portions of the fruit (i.e., the pulp and juice) are forced down into the strainer tube. After the upper cup has descended toward the lower cup, an orifice tube moves upward into the strainer tube. The orifice tube applies pressure into the internal portion of the strainer tube to separate juice and pulp within the strainer tube, collect the core material and discharge the core material out of the bottom of the orifice tube. The core material typically includes membrane, seeds, and peel plugs.

Each of the upper and lower cups, together with the strainer tube and orifice tube, form a single juice extractor unit. Typically, three or more juice extractor units are ganged together to increase production and are positioned in one housing or juice extractor machine. The several orifice tubes of a juice extractor machine may be ganged together, such as by an orifice drive beam that supports each of the orifice tubes and is moveable to reciprocate within the strainer tube. The juice extractor machine and method of extracting juice is further described in U.S. Pat. No. 5,970,861, U.S. Pat. No. 5,992,311, and U.S. Pat. No. 5,996,485, the disclosures of which are hereby incorporated by reference and are assigned to the assignee of the present invention.

Each juice extraction machine is powered by a single motor usually located near the top of the machine. The motor is coupled to a drive shaft via a gear box that extends along the top of the machine. The drive shaft runs three systems on the juice extractor. One system is responsible for the reciprocating motion of the upper cups. Along the drive shaft are two cup cams coupled to a cup drive beam connected to the several upper cups of the juice extractor units. The cup cams rotate with the drive shaft causing the up and down motion of the cup drive beam and therefore, the several upper cups.

The rotation of the drive shaft also runs a system responsible for the reciprocating motion of the orifice tube into the strainer tube as previously described. The drive shaft further has two orifice cams coupled to pull rods extending from the drive shaft to the orifice tubes. The pull rods are in turn coupled to an orifice drive beam connected to the several orifice tubes of the juice extractor units. The orifice cams rotate with the drive shaft causing the up and down motion of the pull rods, orifice drive beam and consequently, the several orifice tubes.

Lastly, the rotation of the drive shaft runs the system responsible for feeding the fruits into the bottom cups of the extractor units. The drive shaft has a cogwheel coupled to a chain that is in turn coupled to another cogwheel of the feed system located adjacent the bottom cup. The feeder system is a cam-driven rotating system of fingers that pick the fruit up one at a time from chutes adjacent a gravity fed conveyor system and tosses it into the bottom cup. This system is appropriately synchronized with the motion of the upper cups so that the fruit is placed in the bottom cup prior to or as the upper cup starts its descent toward the bottom cup.

The drive mechanism of the juice extractor machine just described has several areas which present challenges. For example, in a typical start up procedure, a juice extractor might go from rest to approximately 100 rpm over a very short period of time. These excessive forces and accelerations during start up can lead to cam and cam follower separation such as between the cup cams and the cam followers on the cup drive beam. There is significantly less inertia associated with the drive shaft and connected cams than with the cam followers and cup drive beam. As a result, when the machine is started, the cams quickly accelerate but the cam followers cannot move as quickly, thus separation occurs. Contact between the cup cams and cam followers is effectuated by a series of springs that generate and maintain an upward force on the cup drive beam. Once the cup cams and cam followers become separated, the restoring force of the springs jerks the cup drive beam upward until the cam followers make contact the cams. This generates undesirable pounding or knocking heard during start up.

One way that operators of juice extractors minimize the pounding and knocking during start up is to increase the restoring force generated by the springs. The accelerations and resulting forces during start up are then not large enough to overcome the force maintaining contact between the cams and cam followers. Juice extractors use a series of mechanical springs or a mix of mechanical springs and air springs to maintain contact between the cams and the cam followers on the cup drive beam. When air springs are utilized, an operator prevents knocking by increasing the pressure in the air springs. It is found that during steady state operation, an air pressure of 60 psi is needed to keep the cams and cam followers in constant contact with each other. At this pressure, however, knocking occurs during start up. In order to prevent the machine from knocking during start up, a pressure of approximately 80 psi is required in the air springs. It is not unusual for these machines to be run 24 hours a day, 7 days a week. Consequently, the increased pressure can play a significant role in wear, fatigue, breakage of drive train components, and increased energy consumption.

Another problem that is frequently encountered during start up is misfeeding of fruit into the lower cup due to changes in acceleration and timing. Since the feeding system is driven by the drive shaft, the feeding system also experiences large, abrupt accelerations during start up. Fruit often cannot be fed fast enough during this period leading to occasions where there is no fruit in the bottom cup during a machine cycle. There are also occasions where fruit is picked up by the rotating fingers but, due to the large accelerations, the machine often overshoots the bottom cup, again leading to occasions where there is no fruit in the bottom cup during a machine cycle.

There are also other types of mass production and point-of-purchase juice extractors that operate with similar or different extraction techniques but can have similar types of problems. For example, some machines use cups that are oriented horizontally with respect to each other and other machines slice the fruit in half and then use a reaming technique to extract the juice.

In view of the above problems and drawbacks with previous juice extractor start up procedures, it would be desirable to provide a juice extractor with a control system that prevents problems associated, for example, with separation of cams and cam followers and misfeeding of fruit.

### SUMMARY OF THE INVENTION

The present invention is advantageous because it provides a juice extractor that may achieve steady state operation without the start up problems associated with traditional juice extractors. The invention utilizes a soft start controller coupled to the juice extractor motor to gradually bring the extractor up to its normal operating condition. In this way, the large accelerations and resulting forces that lead to the undesirable effects of knocking and pounding as well as fruit misfeeding are avoided. Previously, a motor starting from rest usually reached its operating voltage in less than approximately one half of a second. With a soft start controller, this time period is expanded to occur over a specific and, preferably, controllable period of time. To reduce the unique problems associated with juice extractors, the ramp up time period should be greater than two seconds. It is preferable that the ramp up time period be at least five seconds. The preferred embodiment uses a ramp up time period of approximately ten seconds.

Gradually increasing the motor voltage from zero to its normal operational voltage over a time period of at least two seconds has several advantages. One advantage in the preferred extractor is that the spring generated restoring force that keeps the cam and cam followers in contact with one another may be significantly reduced. For instance, in the case of a juice extractor having air springs, a soft start controller permits a pressurization of 60 psi instead of the 80 psi required to prevent knocking and pounding. This reduction in air pressure reduces the stresses and wear on the cams, shafts, bearings, gears, belts, etc. This can in turn lead to extended drive train life and reduced operation costs and machine down time.

Another advantage of the present invention is that a controlled start up prevents misfeeding of fruit. Because the accelerations are significantly reduced when start up is spread over an extended time period, pieces of fruit in the feeder system have time to be properly positioned so as to be properly and accurately fed into the extractor.

Still another advantage of the present invention is in trouble shooting technical problems in juice extractors. For instance, it is not uncommon that an extractor becomes clogged with foreign material such as twigs, aluminum foil, and any other type of foreign material. With existing extractors, a technician removes the foreign object(s) from the extractor then pushes the start and stop buttons in a quick series of motions to prevent too much momentum in the case that foreign material is still stuck in the machine. If the foreign objects are still stuck in the machine, allowing the machine to gain too much momentum could cause a catastrophic failure. A soft start controller causes the machine to start slowly. In this way, a technician can more readily check for additional clogs or other technical problems before any serious damage occurs to the machine. Additionally, having a soft start controller allows a technician sufficient time to determine other problems, such as misalignments and timing issues, that permit more accurate machine diagnosis and proper machine adjustments.

These and other objects, advantages, and features of the invention will become more readily apparent to those of ordinary skill in the art upon review of the following detailed description taken in conjunction with the accompanying drawings.

### BRIEF DESCRIPTION OF THE DRAWINGS

FIG. 1 is a perspective view of an automated juice extractor machine incorporating the present invention.

FIG. 2 is a cross-sectional view of a portion of a juice extractor unit showing upper and lower cups, strainer tube, and orifice tube.

FIG. 3 is a schematic of a juice extractor machine illustrating the components of the drive train system including the cams, cam followers, drive beams, air and mechanical springs, and the soft start controller of the present invention.

FIG. 4 is a graph demonstrating the present invention by comparing the motor's ramp up to its normal operational voltage when the motor has no soft start controller and when the motor includes a soft start controller.

### DETAILED DESCRIPTION OF THE DRAWINGS

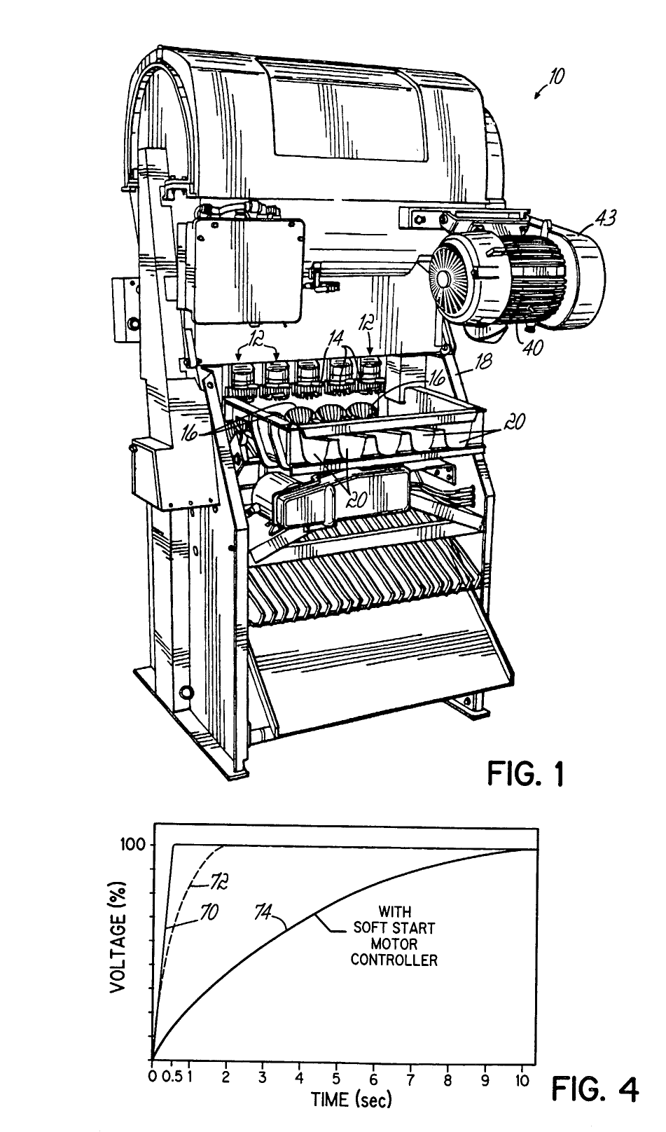

With reference to FIG. 1, a juice extractor machine 10 includes five extractor units 12, each having an upper cup 14 and lower cup 16, ganged together in a common frame 18 and receiving fruit along chutes 20. It will be understood that mass production extractors of other configurations as well as point-of-purchase extractors may also incorporate the principles of this invention with its attendant advantages.

Before a fruit is placed on the individual extractor unit 12, it is unloaded either manually or otherwise into a hopper from which it is conveyed through a washing process, typically a series of brushes where the fruit is gently scrubbed to remove field oils, soil, mold and dust. Fruit is then typically discharged onto a roller grader where workers or automatic sorters select the fruit to remove broken pieces, leaves and other undesirable materials from the flow of fruit supply. The fruit is then typically conveyed to a sizing roller to separate the fruit into sizes equivalent to the size range of the upper and lower cups of the individual extractor units in order to ensure the maximum yield and quality. The fruit is then conveyed to the proper extractor machine 10, such as that shown in FIG. 1 where the individual fruits roll down chutes 20 so that each piece of fruit will nest in the lower cup of the individual extractor units 12.

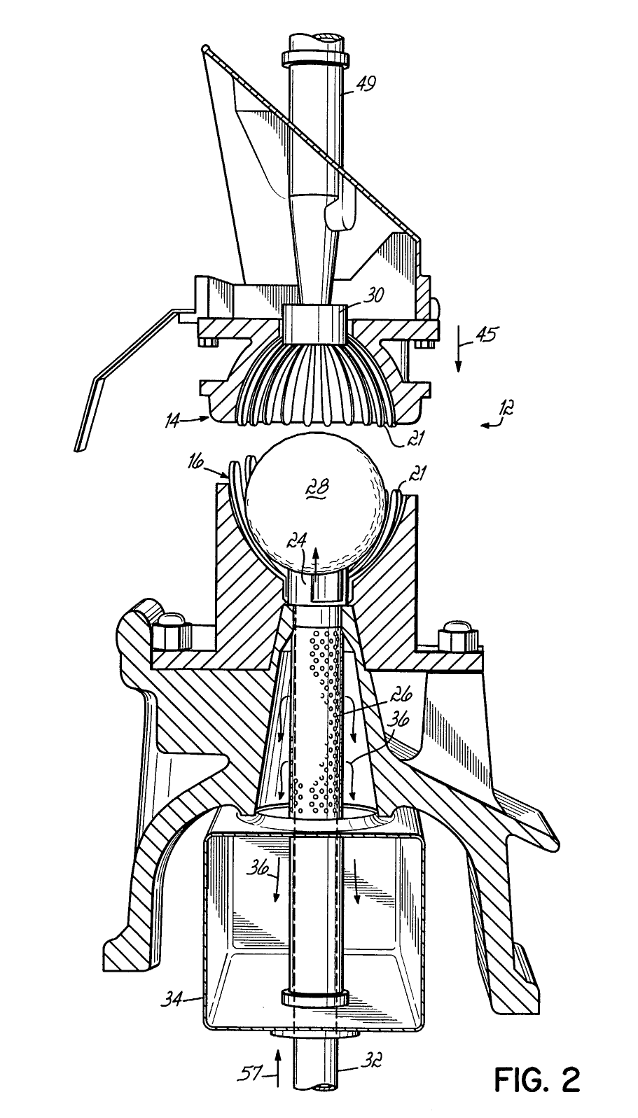

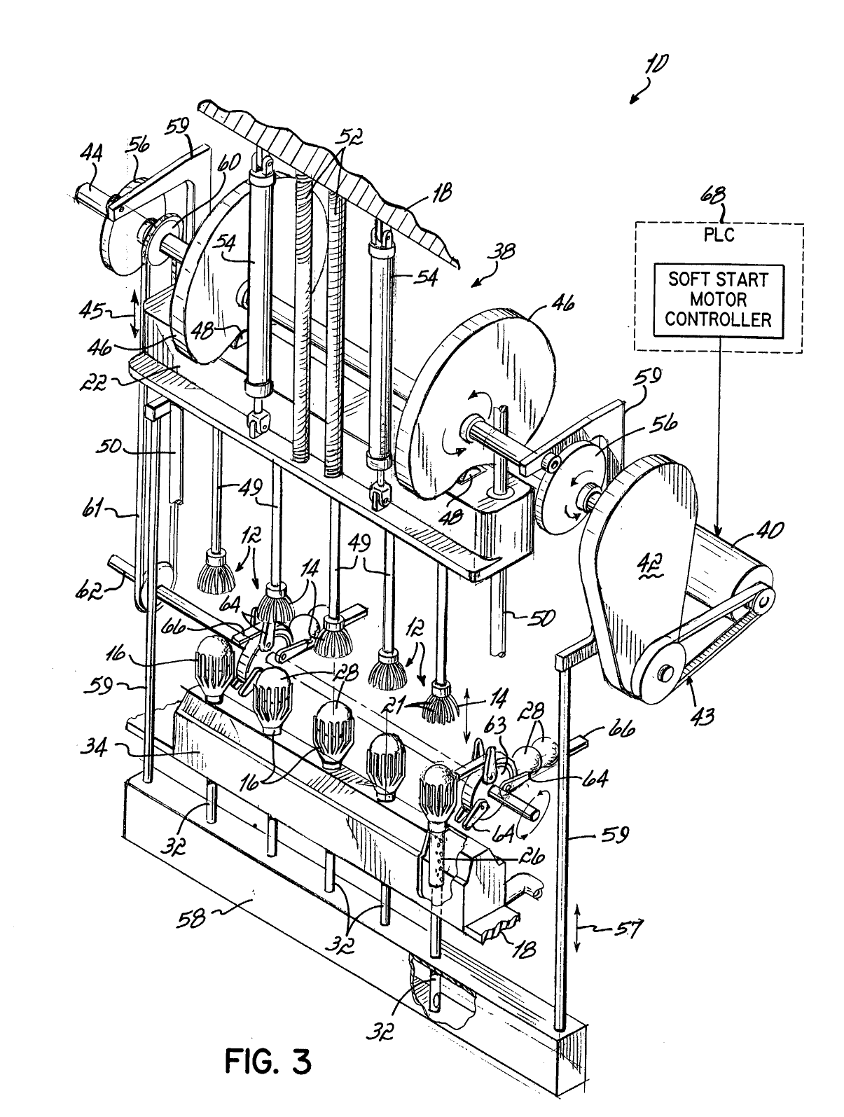

With reference now to FIGS. 2 and 3, there is seen an individual extractor unit 12 with the upper and lower cups 14, 16 respectively. The upper cup 14 is supported on a cup drive beam 22 which moves in a fixed up and down direction by means of a cam-operated drive contained in the top portion of the extractor machine 10. The lower cup 16 is rigidly positioned and secured to the frame 18.

As illustrated, the upper and lower cups 14, 16 are formed as interdigitated cups having fingers 21 that intermesh together as the upper cup is moved into the lower cup. The cam-operated drive system forces the upper cup 14 into the lower cup 16 and presses the fruit 28 against a circular cutter tube 24 located at the base of the lower cup 16 and on top of an elongated prefinishing or strainer tube 26. The cutter 24 cuts a plug in the bottom of the fruit 28 to allow the internal portions of the fruit access to the interior of the strainer tube 26. An upper cutter 30 is associated with the upper cup 14 and cuts a plug in the top of the fruit to permit separation of the peel from the internal portions of the fruit 28 as the fruit is squeezed between the upper and lower cups 14, 16. The inner portion of the fruit 28 is forced down into the strainer tube 26, and an orifice tube 32 received on the interior of the strainer tube 26 moves upwardly to force the inner portions of the fruit 28 that are appropriately sized through the strainer tube and into a juice manifold or reservoir 34, where the juice and pulp 36 is collected. The orifice tube 32 is supported on an orifice drive beam 58 vertically moveable on bushings by means of pull rods 59 coupled to the cam mechanism located in the upper portion of the machine 10, as mentioned before.

With reference now to FIG. 3, there is seen a juice extractor machine 10 and its associated cam-driven power train 38. The juice extractor machine 10 is powered by a motor 40 located near the top of the machine. A gear box 42 is coupled to the motor 40, by means of a belt and pulley system 43, so as to control the rotation of a primary drive shaft 44 that runs along the top of the juice extractor machine 10. Drive shaft 44 runs three systems on the juice extractor machine 10. One system driven by drive shaft 44 is responsible for the reciprocating motion of the upper cups 14, as shown by reference numeral 45. Two cup cams 46 are securely fixed to drive shaft 44 so as to rotate with drive shaft 44. Cup cams 46 are appropriately shaped so as to provide a full up and down cycle with each rotation of the cam. The cup cams 46 are in contact with two cam followers 48 located within cup drive beam 22 which are connected to upper cups 14 by connection rods 49. The cup drive beam 22 moves in a vertical direction 45 along drive beam guides 50 as cams 46 rotate. To keep cup cams 46 and cam followers 48 in constant contact with one another, a series of springs 52, 54 are used to generate and maintain an upward force on the cup drive beam 22. In the preferred embodiment, there are four mechanical springs 52 and four air springs 54, only two are shown for purposes of illustration. The air springs 54 are primarily responsible for maintaining contact between the cup cams 46 and cam followers 48. The mechanical springs 52 provide a minimal level of restoring force and is primarily relied upon for backup and safety concerns. However, those of ordinary skill in the art will recognize that any combination of air springs and mechanical springs may be used to maintain contact between the cams and cam followers, including using all mechanical springs.

Another system driven by drive shaft 44 is responsible for the reciprocating motion of the orifice tube 32 inside the strainer tube 26, as shown by reference numeral 57. Two orifice cams 56 are securely fixed to drive shaft 44 so as to rotate with drive shaft 44. Orifice cams 56 are appropriately shaped so as to provide a full up and down cycle with each rotation of the cam. Pull rods 59 couple the orifice cams 56 to an orifice drive beam 58 that is connected to the several orifice tubes 32. The orifice drive beam 58 moves in a vertical direction 57 along drive beam guides 50 as cams 56 rotate. The orifice cams 56 are also configured such that the upward motion of the orifice tube 32 is slightly behind the downward motion of the upper cups 14.

The drive shaft 44 also runs the system responsible for feeding the fruit to the lower cups 14 of each juice extractor unit 12. A cogwheel 60 is securely fixed to drive shaft 44 so as to rotate with drive shaft 44. A chain 61 couples the primary drive shaft 44 to a secondary drive shaft 62 that rotates a fruit cam 63 having three fingers 64 extending therefrom. As the fruit cam 63 rotates, the fingers 64 picks up fruits 28 one at a time at the bottom of chutes 20. The fruit 28 runs along a fruit guide rail 66 that ends just prior to lower cups 16. As the fruit cam 63 continues to rotate, the fruit 28 is essentially tossed into the lower cup 16. The feeder system is configured such that the fruit is placed in the lower cup prior to or as the upper cup starts its descent toward the lower cup.

To overcome the problems associated with previous juice extractor start up procedures, a soft start motor controller 68, such as the Allen-Bradley SMC-3™ controller, is coupled to the juice extractor motor 40. Now referring to FIG. 4, it is seen by curve 70 that motors without a soft start controller have a natural ramp up curve at start up. Starting from rest, a motor without a soft start controller will typically reach its normal operating voltage in less than approximately one half of a second. As shown by curve 72, to receive any mechanical benefits, the ramp up time period should not be less than two seconds and is preferably between five and fifteen seconds. In the preferred embodiment, the ramp up time period is approximately ten seconds, as shown in curve 74.

In operation, a juice extractor 10 with a soft start controller 68 significantly reduces the accelerations, forces, and resulting stresses experienced by the drive train system 38 during start up and steady state. Because motor 40 of juice extractor 10 is gradually brought up to its normal operating voltage, the acceleration on drive shaft 44 and cup cams 46 are not so high that cams 46 and cam followers 48 separate. This has the advantageous result that air springs 54 do not have to be over pressurized to prevent knocking but may be set at its lower steady state value, e.g. 60 psi instead of 80 psi. Additionally, a soft start controller 68 reduces misfeeds during start up. Due to the high accelerations of non-controlled start up, fruit feeding from chute 20 may not keep up with the rotation of fruit cam 63 or fruit moving along guide 66 by fingers 64 might overshoot the lower cup 16. With a controlled start up that gradually brings the extractor up to speed, the fruit fed from chute 20 may keep up with fruit cam 63 and fingers 64 do not propel fruit 28 beyond the lower cup 16.

While the present invention has been illustrated by a description of a preferred embodiment and while this embodiment has been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims.

What is claimed is:

1. An extractor for obtaining juice from a fruit having a peel, the extractor comprising:
first and second cups for supporting the exterior of a fruit, at least one of the first and second cups movable toward and away from the other cup to separate the peel from the fruit and squeeze the fruit therebetween;
a motor coupled to at least said one cup for reciprocating said one cup toward and away from the other cup, the motor having a normal operating voltage; and
a control coupled to the motor, the control configured to operate the motor such that said motor achieves its normal operating voltage after start up in a period of time greater than two seconds.

2. The extractor according to claim 1, further comprising:
a drive shaft coupled to said motor and configured to rotate about a central axis;
at least one cam fixed to said drive shaft;
a drive beam coupled to said cam and further coupled to said one cup, the cam configured for reciprocating the drive beam; and
at least one spring coupled to the drive beam and configured to maintain constant contact between the drive beam and the cam.

3. The extractor according to claim 2, wherein the springs are mechanical springs.

4. The extractor according to claim 2, wherein the springs are at least one of a mechanical spring and an air spring.

5. The extractor according to claim 1, further comprising:
a strainer tube having a plurality of holes therein, said strainer tube positioned to receive juice and pulp of the fruit after separation from the peel; and
an orifice tube coupled to said motor and movable within the strainer tube, the orifice tube forcing juice outwardly through the holes in the strainer tube.

6. The extractor according to claim 1, wherein said period of time is at leave five seconds.

7. An extractor for obtaining juice from a fruit having a peel, the extractor comprising:
first and second cups for supporting the exterior of a fruit, at least one of the first and second cups-movable toward and away from the other cup to separate the peel from the fruit and squeeze the fruit therebetween;
a motor coupled to at least said one cup for reciprocating said one cup toward and away from the other cup, the motor having a normal operating voltage; and
a control coupled to the motor, the control operable to adjust the period of time over which the motor achieves its normal operating voltage after start up.

8. The extractor according to claim 7, further comprising:
a drive shaft coupled to said motor and configured to rotate about a central axis;
at least one cam fixed to said drive shaft;
a drive beam coupled to said cam and further coupled to said one cup, the cam configured for reciprocating the drive beam; and
at least one spring coupled to the drive beam and configured to maintain constant contact between the drive beam and the cam.

9. The extractor according to claim 8, wherein the springs are mechanical springs.

10. The extractor according to claim 8, wherein the springs are at least one of a mechanical spring and an air spring.

11. The extractor according to claim 7, further comprising:
a strainer tube having a plurality of holes therein, said strainer tube positioned to receive juice and pulp of the fruit after separation from the peel; and
an orifice tube coupled to said motor and movable within the strainer tube, the orifice tube forcing juice outwardly through the holes in the strainer tube.

12. An extractor for obtaining juice from a fruit, the extractor comprising:
movable juice extraction structure configured to receive the fruit and extract juice therefrom;
a motor coupled to said juice extraction structure for operating said juice extraction structure, said motor having a normal operating voltage; and
a control coupled to the motor, the control configured to operate the motor such that said motor achieves its normal operating voltage after start up in a period of time greater than two seconds.

13. A method of operating a juice extractor to remove juice from a fruit having a peel, the extractor being powered by a motor having a normal operating voltage, the method comprising:
supporting the exterior of the fruit with first and second cups;
activating the motor with a controller such that the motor reaches its normal operating voltage over a start up period of time greater than two seconds; and
removing the peel from the fruit and squeezing the fruit by moving at least one of the first and second cups toward the other cup with the motor.

14. The method of claim 13 further comprising:
rotating a drive shaft coupled to the motor, the drive shaft having at least one cam fixed thereto and rotating therewith;
reciprocating a drive beam coupled to the cam and further coupled to said one cup; and
maintaining contact between the drive beam and the cam using one or more springs.

15. The method of claim 13 further comprising:
receiving the juice and pulp of the fruit within a strainer tube;
reciprocating an orifice tube into and out of the strainer tube using the motor.

16. The method of claim 13, wherein the start up period of time is at least five seconds.

17. A method of operating a juice extractor to remove juice from a fruit having a peel, the extractor being powered by a motor having a normal operating voltage, the method comprising:
supporting the exterior of the fruit with first and second cups;
adjusting the period of time over which the motor reaches its normal operating voltage after start up; and
removing the peel from the fruit and squeezing the fruit by moving at least one of the first and second cups toward the other cup with the motor.

18. The method of claim 17 further comprising:
rotating a drive shaft coupled to the motor, the drive shaft having at least one cam fixed thereto and rotating therewith;
reciprocating a drive beam coupled to the cam and further coupled to said one cup; and
maintaining contact between the drive beam and the cam using one or more springs.

19. The method of claim 17 further comprising:
receiving the juice and pulp of the fruit within a strainer tube;
reciprocating an orifice tube into and out of the strainer tube using the motor.

20. A method of operating a juice extractor to remove juice from a fruit, the extractor being powered by a motor having a normal operating voltage, the method comprising:
activating the motor with a controller such that the motor reaches its normal operating voltage over a start up period of time greater than two seconds; and
extracting juice from the fruit by moving at least a portion of the extractor against the fruit with the motor.
